(19) United States
(12) Patent Application Publication
(10) Pub. No.: US 2018/0282116 A1
(43) Pub. Date: Oct. 4, 2018

(54) METHOD AND DEVICE FOR GENERATING CONTROL DATA FOR CONTROLLING AN ELEVATOR SYSTEM BY MONITORING A THERMAL IMAGE OF AN OPERATING SURFACE

(71) Applicant: Inventio AG, Hergiswil (CH)

(72) Inventors: Reto Tschuppert, Luzern (CH); Martin Kusserow, Luzern (CH)

(21) Appl. No.: 15/764,893

(22) PCT Filed: Sep. 9, 2016
(86) PCT No.: PCT/EP2016/071248

§ 371 Date: Mar. 30, 2018

(30) Foreign Application Priority Data
Sep. 30, 2015 (EP) 15187668.7

(51) Int. Cl. B66B 1/46; B66B 1/34

(52) U.S. Cl. CPC B66B 1/463; B66B 2201/4676; B66B 2201/4623; B66B 1/3461

(57) ABSTRACT

A method for generating control data for controlling an elevator system includes the steps:
Projecting or depicting an image of an operating panel on an operating surface to be visually perceived by a user; Detecting a region of the surface, touched by the user, within the image by optically monitoring the surface, then detecting whether a small-area region arises within the image with a temperature deviating from the surrounding large-area regions and with a temperature equalizing with the temperature of the surrounding regions over time; Generating the control data as a function of a position of the region touched by the user relative to the image; Transmitting the generated control data to a control device of the elevator system. The method may be implemented using a portable device carried by the user and equipped with a projector and an infrared camera thereby eliminating conventional operating panels in the elevator system.

### FIELD

The present invention relates to a method and a device for generating control data for controlling an elevator system. The invention furthermore relates to a method and a control device for controlling an elevator system and to an elevator system provided therewith, a computer program product that may be used for this, and a computer-readable medium storing such a computer program product. In addition, the invention relates to use of a portable device for implementing such a method.

### BACKGROUND

Elevators are used, inter alia, to convey passengers between different floors within a building. In general, a passenger must be able to tell a control unit of the elevator system, via a human-machine interface (HMI), where the control unit should cause the elevator car to go. To this end, a car operating panel (COP) with which a passenger who has entered the elevator car can indicate the floor to which he wants to be taken is normally provided in the interior of the elevator car. Furthermore, landing operating panels (LOP) with which a passenger may indicate, for instance, that an elevator car should be moved to the floor in which he is currently located are provided on the floors in the access region for the elevator system.

Normally both the car operating panel and the landing operating panels are generally embodied as devices to be provided separately and with which the passenger may indicate his commands to the control unit of the elevator system, for instance by manually actuating operating surfaces. The operating surfaces are normally frequently embodied in the form of buttons that may be actuated, for instance, mechanically or capacitively.

As a rule, providing operating panels for an elevator system means, inter alia, that hardware required for this must be produced and installed in the elevator system. In general, this involves significant production and installation costs. In addition, hardware required for this may be subject to a risk of failure, for instance due to wear, so that significant maintenance costs may ensue.

There may therefore be a need for a method and a device for generating control data for controlling an elevator system, which method and device can be used to reduce the previous associated costs, installation costs, and/or maintenance costs. Furthermore, there may be a need for a method and a control device for controlling an elevator system and for an elevator system equipped with such a control device that are embodied to use control data generated in this manner. In addition, there may be a need for a computer program product that, when executed by a processor, instructs the latter to implement a corresponding method, and there may also be a need for a computer-readable medium on which such a computer program product is stored. Finally, there may be a need for using a portable device that to be carried by a passenger to implement such a method.

### SUMMARY

According to a first aspect of the present invention, described is a method for generating control data for controlling an elevator system, which method has at least the following method steps. An image of the operating panel is projected such that it is visually perceived by a user on an operating surface. Then it is detected whether a region of the operating surface within an image of the operating panel has been touched by a user. Such detection is made by optically monitoring the operating panel to determine whether a small-area region arises, within the image of the operating panel, with a temperature deviating from the surrounding large-area regions and with a temperature equalizing with the temperature of the surrounding regions over time. Then control data are generated as a function of a position of the region touched by the user of the operating surface relative to the image of the operating panel. The control data generated in this manner are then transmitted to a control unit of the elevator system.

Possible features and advantages of embodiments of the present invention may be considered, inter alia, to be dependent on the ideas and findings described hereinbelow.

As indicated in the foregoing, in the past control data for controlling an elevator system have generally been generated using operating panels reserved especially for this purpose. To be able to reduce production, installation, and/or maintenance costs accruing for this reason, it is suggested, generally speaking, that a type of virtual operating panel be implemented in which an image of an operating panel is projected such that it is visible for a user, but no special structural or device-related measures to be provided are necessarily provided in the elevator system. It should be possible to project the image of the operating panel such that the user can visually perceive, that is, can see, the virtual operating panel on an operating surface. The virtual operating panel may be part of an augmented reality for the user. To this end, the operating surface may in principle be any surface, for instance a surface within the elevator car or a surface on a floor of a building, for instance, next to an elevator door. The image of the operating panel may thus be, for example, an image of a car operating panel (COP) and/or of a landing operating panel (LOP).

To be able to input his instruction or request to the elevator system, a user or passenger may briefly touch an appropriate region of the operating surface within the image of the operating panel. Different regions of the operating surface may be appropriately marked by the image of the operating panel projected thereon such that the user may perceive them as actuating surfaces, similar to knobs and buttons for conventional COPs and LOPs. A user may thus touch one of these regions on the operating surface, which regions have a small area compared to the entire image of the operating panel, and thus “actuate” in a manner similar to that for conventional operating panels.

To detect that the user has touched a small-area region of the image of the operating panel on the operating surface, the operating surface is optically monitored, for instance using a type of infrared camera.

During such optical monitoring, it is continuously checked, or it is checked at brief temporal intervals, whether a small-area region that has a temperature deviating from a surrounding larger-area region arises within the image of the operating panel on the operating surface. The deviating temperature may be higher or lower than that of the surrounding large-area regions. The locally deviating temperature of the small-area region may be used as an indication that a user previously briefly touched the small-area region with his hand or finger locally, heating or cooling said small-area region. The small-area region may correspond, for instance, to a surface area of a fingertip or parts of a hand, that is, for instance a surface area of between 0.5 and 20 cm², preferably between 1 and 5 cm².

As another indication for evaluating whether a small-area sub-region has been “actuated” within the projected image of the operating panel by local touching, it is monitored whether a temperature within the small-area region that deviates from the surrounding large-area regions equalizes the temperature of the surrounding regions over the course of time. This may be an indication that the small-area region was previously briefly touched by the user and its temperature was thereby changed, but that this change in temperature fades with time and is thus temporally limited. In this manner, it may be detected that the locally different temperature of the small-area region was actually occasioned by a touch from the user and is not caused, for example, by other temporally more permanent effects.

As soon as a region of the operating surface touched by the user has been detected, its position relative to the image of the operating panel may be determined. In other words, where the user attempted to “actuate” the virtually projected operating panel may be detected. From this it is possible to derive, for instance, the floor to which the user wants to be transported using the elevator or which other function of the elevator the user wants to activate. Then control data for controlling the elevator system are appropriately generated based on the detection of the position of the region of the operating surface touched by the user relative to the image of the operating panel.

Finally, these generated control data are transmitted to a control unit for the elevator system so that the control unit, for instance, can appropriately actuate a drive of the elevator system to move the elevator car to a desired floor.

According to one embodiment, in the method suggested herein the image of the operating panel may be projected, and the region of the operating surface touched by the user may be detected, by means of a portable device to be carried by the user. Such a portable device may be, for example, a “smart phone,” a “smart watch,” smart eyeglasses, sometimes also called a head-mounted display (HMD), such as, e.g. “smart glasses” or “Google glasses,” or a “smart garment.”

These days, such portable smart devices to be carried by a user may be equipped with various compact components that can make it possible to project images, optically monitor regions of an area, and/or analyze, further process, and ultimately transmit associated data or signals to other devices.

For instance, portable smart devices may be equipped with a miniaturized projector (“beamer”) that may be used to project images such that they may be visually perceived by a user on an operating surface. In addition, such intelligent portable devices may have optical sensors, for instance in the form of a spatially resolving and/or temporally resolving camera that may be used to optically monitor surrounding regions. Such sensors or cameras may in particular be embodied similar to an infrared camera to detect thermal radiation in the form of infrared radiation (IR). The sensors or cameras may in particular be designed to supply spatially resolved recordings of the surroundings in order to be able, for instance, to detect a small-area region having a temperature deviating from surrounding large-area regions. In addition, the sensors or cameras may be designed to monitor a surroundings in a temporally resolved manner in order, for instance, to be able to detect that the initially deviating temperature of the aforesaid small-area region equalizes with the temperature of the surrounding regions over time.

The portable smart device may furthermore have a central processing unit (CPU) and memory that permit it, for instance, to produce a projecting image and/or to analyze and further process image data supplied by sensors or a camera.

Furthermore, portable smart devices are designed for transmitting data to other devices in a wired or wireless manner. Thus, for instance, control data that were first generated by analysis of image data supplied by the sensors or camera may be transmitted to a control unit of the elevator system.

One concept behind the idea of implementing the projection, according to the method, of the image of the operating panel, and the detection, also to be provided according to the method, of the region of the operating surface touched by the user by means of a portable smart device to be carried by the user, may be seen in that in this manner it is to a large extent possible to do without equipment that is permanently installed in an elevator system for generating control data for controlling the elevator system. For instance, instead of having to provide a permanent COP in an elevator car and a permanent LOP on each floor of a building, and having to expend significant resources in producing these devices, installing them, and in particular wiring and maintaining them, it is proposed that functions of such equipment, previously installed to be stationary, be assumed largely by devices that the users of the elevator normally have with them in any event for other purposes and that then may be specially configured for generating control data for controlling the elevator system.

Similar to the “bring your own device” (BYOD) concept, passengers of an elevator may thus then use their own, familiar portable device, such as, for example, their own smart phone, for instance using an application (“app”) specially provided for this purpose, to instruct the elevator system to send an elevator car to their current location, for instance, or, after entering the elevator car, to instruct the elevator system to move the elevator car to a desired floor.

Use of portable devices to be carried by passengers as a replacement for or in addition to conventional COPs or LOPs may also be used advantageously in that, for example, during the process of generating control data for controlling the elevator system, an identity and/or authorizations for the passenger carrying the portable device may be taken into account.

For instance, it may be provided that only certain users of the elevator system are to be conveyed to special floors of a building and are to have access to them. Consequently, these specially authorized users may specially configure in advance, for instance, their portable devices that are to be carried with them, for instance by inputting an authorization code to be provided by the elevator system operator, so that when the operating panel is projected an image of an operating panel is visually displayed only to them and may also be used to select restricted-access floors of a building. On the other hand, an operating panel is visually displayed to unauthorized persons in which the existence of such restricted-access floors is not even identifiable or indicated, for instance, so that such floors cannot be selected.

Alternatively, to using portable devices of the passengers, the image of the operating panel may also be projected using devices that are part of the elevator system and/or the regions of the operating surface touched by the user may be detected using devices that are part of the elevator system. For instance, a projector may be provided that projects an image of the operating panel onto an operating surface in a manner that may be visually perceived by the user. In addition, a camera or sensors may be provided for the elevator system, by means of which camera or sensors the operating surface may be optically monitored such that it may be detected when a passenger touches a region of the operating surface onto which the operating panel was projected and in this manner attempts to actuate it. As a rule, the provision of such additional hardware for the elevator system involves additional production and installation costs, but it may advantageously permit, for instance, operating panels customized individually for each elevator passenger to be projected and thus, for instance, only provide authorized passengers access to restricted-access floors by means of the projected image of the operating panel. In addition, adaptations of a virtual operating panel depicted by projection may be implemented simply in terms of software without it being necessary to modify or wear devices or other hardware for this.

According to another embodiment of the invention, the image of the operating panel is projected directly onto or depicted directly on the operating surface that is either projected by a device of the elevator system or likewise serves as the operating surface of a mobile device, such as e.g. the touchscreen of a smartphone. In other words, the image of the operating panel may be projected directly to the operating surface in an elevator car or may be temporarily depicted as an image of the operating panel of a mobile device, so that the operating panel reproduced is visually perceived by the user of the elevator system on the operating surface.

Projecting the operating panel onto the operating surface in this manner may be implemented in a simple manner, in particular when a projector provided for this purpose is permanently installed on the elevator system so that the image of the operating panel may be depicted on the operating surface sharply focused and without distortions. A portable device to be carried by the user, such as for instance a smart phone, may also be able to project an image of an operating panel onto the operating surface in a suitable manner. In this case, it may be advantageous, for instance, when the portable device can determine in advance its position and/or orientation relative to the operating surface in order to be able then to project the image of the operating panel such that it is sharply focused and undistorted.

In principle, any desired unoccupied surface, in or on the elevator system, that may be observed externally by a user may be used for the operating surface. The color of the operating surface is preferably kept neutral, that is, for instance it is of a single color and is preferably kept in a light hue, especially white. Operating panels projected onto such an operating surface are thus easily visually perceived by a user. The operating surface is preferably flat. For instance, the operating surface may be a surface of a wall covering in an elevator car or on a building floor adjacent to an elevator door. The operating surface or a component bearing it may be passive, that is, does not have to be controllable or regulatable in any manner, and consequently also does not necessarily need to have electrical connectors or the like.

Preferably a component providing the operating surface may be produced from a metal or structurally embodied such a thermal capacity is created in the region of the operating surface such that the user touching the operating surface in a typically brief manner leads to a measurable and detectable change in temperature in a small-area region of the operating surface. To this end, metal materials or even plastic materials or natural materials may be used for forming the operating surface.

Alternatively, according to one embodiment it may be provided that the image of the operating panel is projected directly into the eye of the user.

For instance, a projector of intelligent glasses may be provided to project images directly onto the retina of the eye of an observer. In this case, an image may be projected into merely one eye or, alternatively, into both eyes, of the observer. A user of an elevator may look at a surface area that appears suitable as an operating surface for this so that an image of an operating panel projected into his eye affects the observer as if this operating panel was being projected onto the operating surface. The user may then manually touch specific small-area sub-regions of the projected operating panel in order to actuate control functions depicted on the operating panel, that is, for instance, in order to select a floor to which the elevator car is to travel.

In this case, it is possible to make advantageous use of the fact that image projected into the eye of the user is visually perceptible solely to the user. That is, while the operating panel is visible on the operating surface for the user, other persons in the area are not able to see this operating panel. In this way, the privacy of the user may be better protected, since other people in the area cannot detect, for example, which floor the user wants to travel to. If the user is authorized, for instance, to travel to restricted-access floors, he may thus in particular input control data for the elevator system regarding this, without other passengers in an elevator car being able to detect this.

According to one embodiment, the control data are transmitted wirelessly to the control unit of the elevator system.

Such wireless data transmission may be advantageous, in particular, when a portable device to be carried by the user is used for projecting the image of the operating panel, detecting the region of the operating surface touched by the user, and/or for generating the control data. This device may then preferably communicate wirelessly with the control unit of the elevator system, so that, for instance, the user does not inconveniently have to physically connect his portable device to the control device of the elevator system.

Data may be transmitted wirelessly directly to the control user of the elevator system, for instance using a WLAN (wireless local area network). Alternatively, for instance, a smart phone used as a portable device may transmit corresponding data, for instance via an internet access, to a “cloud,” and from there the data may then be forwarded to the control unit of the elevator system, for instance by an operator of the elevator system.

According to a second aspect of the invention, a device for generating control data for controlling an elevator system is suggested, wherein the device is embodied to implement a method according to one embodiment of the previously explained first aspect of the invention.

To this end, the device may have a projector for projecting an image of the operating panel such that it is visually perceived by a user on an operating surface, and may have a spatially resolving infrared camera for detecting, using optical monitoring of the operating surface, regions of the operating surface within the image of the operating panel touched by the user, detecting whether within the image of the operating panel small-area regions arise with a temperature deviating from the surrounding large-area regions and with a temperature equalizing with the temperature of the surrounding regions over time. Furthermore, the device may have a central processing unit for generating the control data as a function of a position of the regions of the operating surface touched by the user relative to the image of the operating panel and may have a data transmission unit for transmitting the generated control data to a control unit of the elevator system.

For instance, the device may be a portable device to be carried by a user as was described in the foregoing in the context of the method to be implemented. The device may in particular be equipped with controllable light sources acting as a projector and with light sensors acting as a spatially resolving infrared camera. The central processing unit may be configured to suitably control the projector in order to use it to project the image of the operating panel such that it is visually perceived by the user. In this case, for instance, relative positioning of the portable device with respect to the operating surface may be taken into account. Furthermore, the central processing unit may be equipped to analyze image data that are supplied by the spatially resolving infrared camera in order to detect from said data whether, for instance, a small sub-region of a thermal image is locally warmer or colder than surrounding large-area regions, but its temperature later equalizes with the temperature of the surrounding areas, so that it may be concluded therefrom that a user previously touched this region and in this way modified its temperature. The central processing unit may furthermore analyze whether the region touched by the user corresponds to a prespecified region within the projected image of the operating panel, by means of which a specific function of the elevator system is to be activated, for instance. Then the central processing unit may generate appropriate control data for the elevator system and transmit said data to the control unit of the elevator system by means of the data transmission unit. The portable device may be configured for this, for instance using specially provided software (an “app”) in order to appropriately control and use hardware present in the portable device.

According to a third aspect of the invention, a method for controlling an elevator system is described. In addition to the aforesaid generation of control data by means of a method according one embodiment of the first aspect of the invention described in the foregoing, the method also includes receiving the transmitted control data and controlling the elevator system based on the received control data.

In other words, in this aspect of the invention, the control data generated according to the aforesaid first aspect of the invention are not only produced, but are then also received by components of the elevator system enabled for this, that is, for example, its control device, in order to then be able to control functions of the elevator system based on these received control data.

In one embodiment of this method, furthermore, controlling the elevator system may be authorized in that an authorization code is received in addition to the control data. Such an authorization code may indicate, for instance, that a person possessing a portable device used for generating the control data is authorized to activate certain functions of the elevator system, such as, for instance, accessing restricted access floors. To this end, it may be provided, for instance, that an appropriate authorization code has been stored in advance in the user's portable device. Alternatively, a user may be prompted, for instance, to enter an authorization code into his portable device, or alternatively, via the projected operating panel, if he wants to activate the execution of an elevator function that is subject to a restriction. As another alternative, it may be provided, for instance, that a user must carry with him or couple to his portable device a separate component, for instance in the form of a token, wherein this token may then generate and/or emit the authorization code.

According to a fourth aspect of the invention, a control device for controlling an elevator system is described. In addition to a device according to the second aspect of the invention described in the foregoing, this control device has a receiver unit for receiving transmitted control data and a control unit for controlling the elevator system based on the received control data.

According to a fifth aspect of the invention, an elevator system is provided that, in addition to a control device according to the fourth aspect of the invention described in the foregoing, has an operating surface, wherein the operating surface has a temperature control device in order to be able to vary a surface temperature of the operating surface in a targeted manner.

Aside from the temperature control device, the operating surface does not have any separate equipment or components. The temperature control device may be a heating or cooling unit. The temperature control device may be designed in particular to vary the surface temperature of the operating surface across a large surface area, preferably homogeneously across the entire operating surface. For instance, using the temperature control device the operating surface may be brought to a surface temperature that differs significantly from the typical temperature of the hand of a user, that is, for example, significantly cooler than the skin temperature of the hands of a user, for instance cooler than 25° C. Thus, using the temperature control device, the operating surface may be brought to a suitably cool temperature, for example nearly 30° C., even when there are otherwise high ambient temperatures, so that small-area regions touched by a user, due to the touch, may temporarily have a temperature that detectably deviates from surrounding regions, which then may be detected by an infrared camera, for example.

According to a sixth aspect of the present invention, a computer program product is suggested that has computer readable instructions that, when executed by a processor, instruct the latter to control a method according to one of the embodiments of the first or third aspect of the invention. Such a computer program product may be software programmed in a desired programming language. The computer program product may be, for instance, an application (“app”) that is designed to be embodied on a portable smart device. The computer-readable instructions of the computer program product may instruct a data processing unit of this device to execute steps of an inventive method or to appropriately control components connected to the data processing unit, such as for instance a projector or an infrared camera or data transmission unit.

According to a seventh aspect of the present invention, a computer-readable medium is suggested on which a computer program product according to the sixth aspect of the invention is stored. Such a computer-readable medium may be, for example, any medium on which computer-readable instructions may be stored in a manner that is computer-readable. In particular, the computer-readable medium may be designed to store the instructions such that they may be retrieved electrically and/or magnetically. The computer-readable medium may be, for instance, a CD, a DVD, a flash memory, an EPROM, an EEPROM or parts such as, for instance, Internet servers, from which the stored computer program product may be downloaded.

According to an eighth aspect of the present invention, the use of a portable device for implementing a method according to embodiments of the first or third aspect of the invention is suggested, wherein the portable device has a projector and an infrared camera. In other words, the use of a portable device equipped with a projector and an infrared camera for generating control data or ultimately for controlling an elevator system is suggested.

It should be noted that some of the possible features and advantages of the invention are described here with reference to different embodiments. In particular, some possible features and advantages are described for a method and some are described for a device, wherein the method and the device themselves are designed in part for generating control data for controlling an elevator system and in part for controlling the elevator system. A person skilled in the art recognizes that the described features may be combined, adapted, exchanged, or transmitted as appropriate in order to yield other embodiments of the present invention.

Embodiments of the present invention are described below with reference to the accompanying drawings, wherein neither the drawings nor the description are to be interpreted as limiting the present invention.

### DESCRIPTION OF THE DRAWINGS

FIG. 1 illustrates an elevator system in which a method or a device according to one embodiment of the present invention is to be implemented.

FIG. 2 illustrates smart glasses that are embodied as a device executing an inventive method.

The drawings are only schematic and are not true to scale. Like reference signs refer in different drawings to like or analogous features.

### DETAILED DESCRIPTION

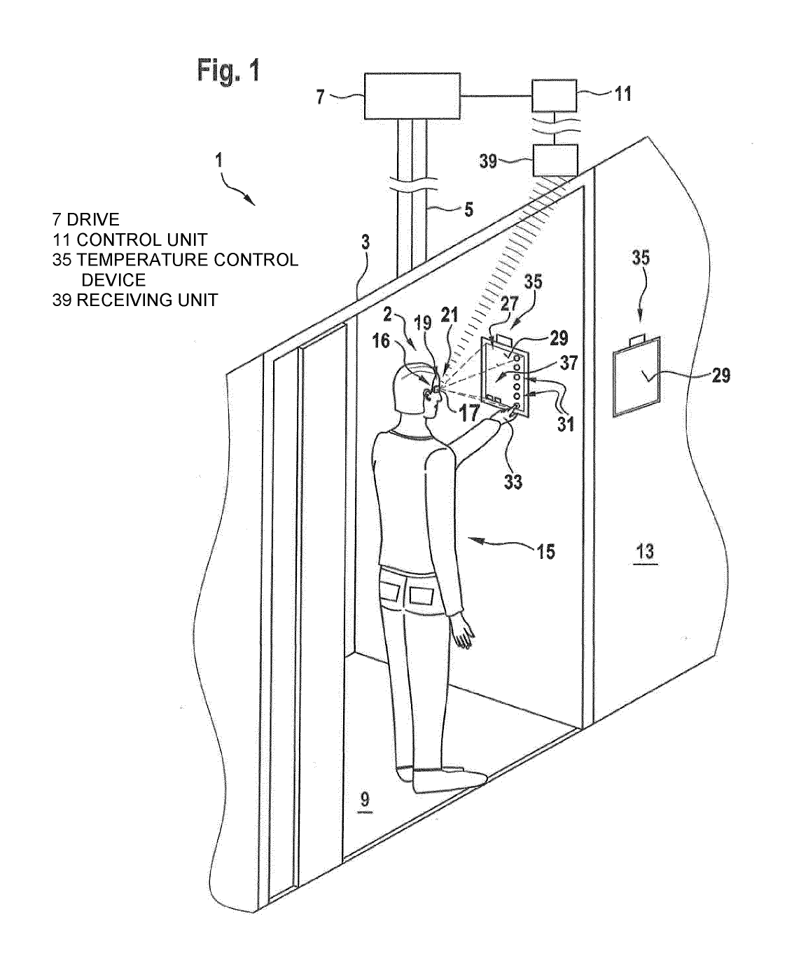

FIG. 1 illustrates an elevator system 1 in which a method and a device 2 are implemented for generating control data for controlling the elevator system 1 according to an embodiment of the present invention. The elevator system 1 has a car 3 that is suspended from suspension means 5, for example in the form of cables or belts, and may be moved vertically within an elevator shaft 9 via a drive 7. The drive 7 is appropriately controlled by a control unit 11 in order, for instance, to move the car 3 to a desired floor 13 within a building.

Conventionally, provided in the elevator car 3 is a car operating panel (COP) on which a user 15 may input a transport request, for instance by pressing buttons. A user 15 waiting on a floor 13 may indicate coming of the elevator car 3 by appropriately actuating a button on a landing operating panel (LOP).

In order to be able to avoid separately providing and installing such LOPs and COPs, and thus the associated production and installation costs, it is suggested that the functions of an LOP and COP be assumed by a type of virtual operating panel.

In this context, it is assumed that in the future users of an elevator system 1 will normally have their own portable devices that can assume, emulate, and/or virtualize such functions of an LOP or COP. Such portable devices to be carried by a user may be so-called “wearables,” such as for instance, a smart phone, a smart watch, smart glasses 17, or a smart article of clothing.

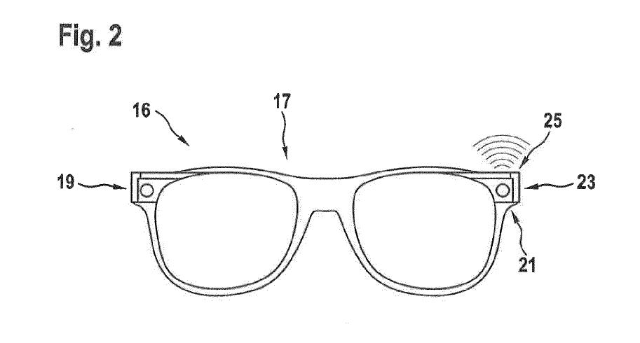

For example, FIG. 2 depicts a portable device 16 in the form of smart glasses 17. The smart glasses 17 may be worn on the face of a user like conventional glasses, and may also be used to correct vision and/or provide protection against the sun, like conventional glasses. In addition, the smart glasses 17 have a projector 19, a spatially and temporally resolving infrared camera 21, a central processing unit 23, and a data transmission unit 25. Using modern microelectronics, all of these components may be embodied with a very small installation space and thus integrated into eyeglasses 17.

The projector 19 may have, for example, a controllable light source, for instance in the form of one or more light-emitting diodes (LED) and/or a projection display, for instance in the form of a liquid crystal display (LCD), so that spatially resolved images may be projected onto a surface disposed in front of the eyeglasses 17 using the projector 19.

Alternatively, the projector 19 may be embodied for projecting images directly into an eye of the user 15.

The spatially-resolving infrared camera 21 may be designed, for instance using a CCD chip or a thermocolumn array, to record infrared images of a surface disposed before the eyeglasses 17 and to convert said images to a sequence of electrical signals.

The central processing unit 23 may have a central data processing unit (CPU) as well as data storage units in order to be able to control, for example, the projector 19, on the one hand, and/or to be able to process and analyze the image data supplied by the infrared camera 21, on the other hand.

Correspondingly further-processed data and signals may finally be transmitted, for instance wirelessly, to other equipment, such as for instance a receiver unit 39 of the elevator system 1, using the data transmitting unit 25.

In order to be able to emulate the task of generating control data for controlling the elevator system 1, a task previously assumed by a COP or LOP, according to one inventive method an image of an operating panel 27 may be projected such that it is visually perceived by, that is, seen by, a user 15 of the elevator system 1 on an operating surface 29. The image of the operating panel 27 may be projected directly onto the operating surface 29 using the projector 21, or alternatively, may be projected into an eye of the user 15 such that the latter sees the image on the operating surface 29.

The projector 21 may be a part of a portable device 16 to be carried by the user 15, that is, for instance, part of the smart glasses 17. Alternatively, the projector 21 may also be provided as a component of the elevator system 1, and, for instance, may be securely mounted in the elevator car 3 or in a region on the floor 13 near an elevator door.

The user 15 that wants to control the elevator system 1 may see on the operating surface 29 the image of the operating panel 27 displayed visually for him and, similar to a conventional COP or LOP, may detect small-area surfaces 31 that may optically represent conventional control buttons. As for conventional operating panels, the user 15 may touch such small-area regions 31 with his hand 33 and thus “actuate” the virtual operating panel 21 in a quasi-conventional manner. However, in this case it is not actual structurally provided buttons that are actuated, but instead regions on a surface that is not otherwise specially prepared for this is touched in or on the elevator system 1.

Because they are touched within the image of the operating panel 27, these small-area regions 31 heat up in a typical manner, however, since the hand 33 of the user 15 is normally warmer than, for instance, a wall of the elevator car 3 acting as the operating surface 29. In special cases, the operating surface 29 could also be warmer than the hand 33 of the user 15, so that the small-area regions 31 are locally cooled when touched by the hand 33 of the user 15.

In order to be able to influence the surface temperature of the operating surface 29 in a targeted manner, a temperature control device 35 may be provided with which the operating surface 29 may be cooled or heated. The temperature control device 35 may thus keep the operating surface 29 homogeneously at a prespecifiable temperature across as much surface area as possible.

In order now to detect which of the actuating button-like small-area regions 31 the user has touched 15 to thereby indicate in particular desired transport by the elevator system 1, the operating surface 29 is optically monitored to determine whether, within the image of the operating panel 27, one of these small-area regions 31 has a temperature deviating from surrounding large-area regions 37. If this is the case, this may be assessed as a first indication that this small-area region 31 was previously touched by the user 15.

As an additional indication, it may be monitored whether the temperature of this small-area region 31 equalizes with the temperature of the surrounding area 37 over time. If this is not the case, it may be assumed that the locally increased temperature was probably not caused by the user 15 having touched it previously, but rather by other effects.

Overall, using the described optical monitoring of the operating surface 27 it may be detected, with high reliability, whether and where the user 15 touched the operating surface 29. Then the control data for the elevator system 1 are generated as a function of an analysis of the position of the region 31 touched by the user 15 of the operating surface 29 relative to the image of the operating panel 27.

These control data may finally then be transmitted to the control unit 11 of the elevator system 1. To this end, the control unit 11 may be connected to the receiver unit 39, which is designed to receive, for instance wirelessly, the generated control data transmitted by the data transmission unit 25 of the portable device 16.

Based on the control data received in this manner, the control unit 11 may then appropriately control the elevator car, that is, in particular, the drive 7, to move the elevator car 3 to a desired position, for example.

Finally, it should be noted that terms such as “comprising” and the like do not preclude other elements or steps, and terms such as “a” or “one” do not preclude a plurality. Furthermore, it should be noted that features or steps that have been described with reference to one of the above embodiments may also be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

### LIST OF REFERENCE SIGNS

1 Elevator system
2 Device for generating control data
3 Elevator car
5 Support means
7 Drive
9 Elevator shaft
11 Control unit
13 Floor
15 User
16 Portable device
17 Eyeglasses
19 Projector
21 Infrared camera
23 Central processing unit
25 Data transmission unit
27 Image of the operating panel
29 Operating surface
31 Small-area region
33 Hand
35 Temperature control device
37 Surrounding region
39 Receiving unit

1. A method for generating control data for controlling an elevator system (1), comprising:
Projecting or depicting an image of the operating panel (27) such that it may be visually perceived by a user (15) on an operating surface (29);
Detecting a region of the operating surface (29), touched by the user (15), within the image of the operating panel (27) by optically monitoring the operating surface (29), then detecting whether a small-area region (31) arises within the image of the operating panel (27) with a temperature deviating from the surrounding large-area regions (37) and with a temperature equalizing with the temperature of the surrounding regions (37) over time;
Generating the control data as a function of a position of the region touched by the user (15) of the operating surface (29) relative to the image of the operating panel (27);
Transmitting the generated control data to a control device (11) of the elevator system (1).

2. The method according to claim 1, wherein the image of the operating panel (27) is projected or depicted and the region of the operating surface (29) touched by the user (15) is detected by means of a portable device (16) to be carried by the user (15).

3. The method according to claim 2, wherein the portable device (16) is a device selected from the group comprising a smart phone, a smart watch, smart glasses (17), and smart clothing.

4. The method according to any of claims 1 through 3, wherein the image of the operating panel (27) is projected or depicted on the operating surface (29).

5. The method according to any of claims 1 through 3, wherein the image of the operating panel (27) is projected directly into at least one eye of the user (15).

6. The method according to any of claims 1 through 5, wherein the control data are transmitted wirelessly to the control unit (11) of the elevator system (1).

7. A device for generating control data for controlling an elevator system (1), wherein the device is designed to implement a method according to any of claims 1 through 6.

8. The device according to claim 7, comprising:
a projector (19) for projecting or depicting an image of the operating panel (27) such that it may be visually perceived by a user (15) on an operating surface (29);
a spatially resolving infrared camera (21) for detecting regions of the operating surface (29), touched by the user (15), within the image of the operating panel (27) by optically monitoring the operating surface (29), then detecting whether a small-area region (31) arises within the image of the operating panel (27) with a temperature deviating from the surrounding large-area regions (37) and with a temperature equalizing with the temperature of the surrounding regions (27) over time;
a central processing unit (23) for generating the control data as a function of a position of the regions touched by the user of the operating surface (29) relative to the image of the operating panel (27);
a data transmission unit (25) for transmitting the generated control data to a control device (11) of the elevator system (1).

9. A method for controlling an elevator system (1), comprising:
Generating control data by means of a method according to any of claims 1 through 6;
Receiving the transmitted control data;
Controlling the elevator system (1) based on the received control data.

10. Method according to claim 9, further comprising:
Authorizing control of the elevator system (1) by receiving an authorization code.

11. A control device for controlling an elevator system, comprising:
a device according to either of claim 7 or 8;
a receiving unit (39) for receiving transmitted control data; and,
a control unit (11) for controlling the elevator system (1) based on the received control data.

12. An elevator system (1), comprising:
a control device according to claim 11,
an operating surface (29), wherein the operating surface (29) has a temperature control device (35) to be able to vary, in a targeted manner, the surface temperature of the operating surface (29).

13. A computer program product that has computer readable instructions that, when executed by a processor, instruct the latter to control a method according to any of claims 1 through 6, 9, and 10.

14. The computer-readable medium, having a computer program product according to claim 13 stored thereon.

15. The use of a portable device that is equipped with a projector (19) and an infrared camera (21) for implementing a method according to any of claims 1 through 6 or a method according to either of claim 9 or 10.
